(19) United States
(12) Patent Application Publication
(10) Pub. No.: US 2008/0050988 A1
(43) Pub. Date: Feb. 28, 2008

(54) CABLE ASSEMBLY GROUND PROTECTOR

(75) Inventor: Melvin Leroy Burger, Cambridge Springs, PA (US)

Correspondence Address: PEARNE & GORDON LLP, 1801 EAST 9TH STREET, SUITE 1200, CLEVELAND, OH, 44114-3108, US

(73) Assignee: Penn-Union Corp., Edinboro, PA (US)

(21) Appl. No.: 11/843,893

(22) Filed: Aug. 23, 2007

Related U.S. Application Data
(60) Provisional application No. 60/839,626, filed on Aug. 23, 2006.

(51) Int. Cl. H01R 4/36

(52) U.S. Cl. 439/814; 439/108

(57) ABSTRACT

A grounding connector comprising a ferrule portion and a pad portion. The ferrule portion has a conductor receiving bore terminating adjacent the transition portion. The transition portion also slopes downwardly from the ferrule portion toward the pad portion to form an obtuse angle with the pad portion. The grounding connector is unitary and seamless.

### CROSS-REFERENCE TO RELATED APPLICATIONS

The present invention claims the benefit of U.S. Provisional Application No. 60/839,626 filed Aug. 23, 2006, the entire disclosure which is herein incorporated by reference.

### BACKGROUND OF THE INVENTION

1. Field of the Invention

The present invention relates to a cable assembly ground connector that reduces the presence of static electricity.

2. Description of Related Art

It is known in the prior art to provide cable assemblies that can ground connected structures. The present invention is an improvement over the prior art as it reduces the amount of static electricity in a ground connector terminal. Reducing the presence of static electricity is especially important in aerospace applications where static electricity can increase and build up to dangerous levels. Typical ground connectors also can be subject to increased forces across a neck or transition area. Strengthening the transition area of the ground connector is also very desirable due to the ground connector being subject to increased torsional vibration and pull-out forces. It is also desirable to develop an efficient process for creating a connector assembly that solves the problems in the prior art.

Prior art connectors fall into two groups. A first style of connector is illustrated in FIG. 5 and comprises a seamless tube 60. A grounding connector is formed by stamping a portion 62 of the connector to form a pad portion 64 and a ferrule portion 66. During the forming operation a pin (not shown) is inserted in the ferrule portion to maintain its cylindrical shape. It should be noted that, while the ferrule portion is cylindrical, the pad portion has a seam 68 which leads to the ferrule portion.

Another example of a prior art connector is shown in FIG. 6. Such a connector is generally stamped with progressive dies to the shape illustrated. A conductor is placed in a trough 70 and wings 72 are crimped over the conductor to form a seamed ferrule with open ends.

### BRIEF SUMMARY OF THE INVENTION

In accordance with the present invention, there is provided a cable assembly ground connector that reduces the amount of static electricity and withstands larger bending strengths. The cable assembly ground connector can be manufactured from a solid rod using a number of different manufacturing processes.

According to this invention a grounding connector comprises a ferrule portion, a transition portion, and a pad portion. The ferrule portion has a conductor receiving bore terminating adjacent the transition portion. The transition portion slopes downwardly toward the pad portion to form an obtuse angle with said pad portion. The grounding connector is unitary and seamless and is preferably plated copper, i.e. nickel, silver, gold or tin.

The connector is manufactured by cutting a solid rod to a predetermined length and is subjected to a turning operation to produce a predetermined diameter for the ferrule portion. The rod is then partially drilled to form the conductor receiving bore of a predetermined depth and diameter. The rod is placed in upper and lower forming dies to form the transitional and pad portions while maintaining the dimensional integrity of the ferrule portion by inserting a rod therein.

### BRIEF DESCRIPTION OF THE DRAWINGS

FIG. 1 is a top view of a first embodiment of the present invention;

FIG. 2 is a front view of a first embodiment of the present invention;

FIG. 3 is a side view of a first embodiment of the present invention;

FIG. 4 is an elevational view of a solid rod embodiment at an intermediate stage in its manufacturing process;

FIG. 5 is a sectional view of a forming die for forming the rod of FIG. 4;

FIG. 6 is a front view of the forming die of FIG. 5;

FIGS. 7 and 8 are examples of prior art connectors.

### DETAILED DESCRIPTION OF INVENTION

It should be evident that this disclosure is by way of example and that various changes may be made by adding, modifying or eliminating details without departing from the fair scope of the teaching contained in this disclosure.

The present invention relates to a cable assembly ground connector, comprising a lug terminal that is formed with increased strength and promotes a better connection with the ground to eliminate the presence of static electricity. The terminal is a seamless one-piece unit and is manufactured from a solid rod. The terminal is comprised of a ferrule portion and a pad portion. The pad area is seamless, thicker and heavier than assemblies found in the prior art. The thickness and weight of the pad area provides improved ultra high wire pull out values. The seamless pad also ensures that moisture will not enter a connecting hole provided on the pad and the ferrule and reduces the chance for corrosion. The terminal has a bore which may be drilled in a ferrule portion for insertion of a grounding wire. The aperture allows a grounding wire to be installed by the use of a manual or hydraulic crimping tool. The wire that is installed in the ferrule portion causes the lug terminal to be grounded. The aperture of the ferrule portion contains a wider opening or counterbore to accommodate the insulation sleeve on the conductor. The ferrule of the terminal has a substantial thickness remaining after the drilling or forming operation is complete.

A transition area connects the ferrule with the pad portion. It is to be appreciated that a pin received in a connecting hole of the pad portion is grounded due to the connectivity of the terminal. The pin that is placed in the connecting hole exerts forces on the terminal, with the forces being especially strong in the transition area between the ferrule and the pad. The transition area contains increased strength properties to withstand various forces that may be applied to it. During testing of the terminal, the transition area and the ferrule showed increased performance for pull-out, vibration, twisting, flexing, weight, thermal shock, and for tensile strength.

In one embodiment, according to FIGS. 1-4, a cable assembly ground connector is comprised of a terminal lug 10. The terminal lug 10 includes a ferrule 12 on one end of the lug and a pad 14 on the other end of the lug. A transition area 16 connects the ferrule 12 to the pad 14. The ferrule 12 contains a blind bore 20 that receives a grounding wire (not shown). The grounding wire is placed into the bore 20 in the ferrule 12. In one embodiment, the ferrule 12 is provided with a counterbore 21 having a diameter greater than the diameter of the blind bore 20. The counterbore 21 provides space for cable insulation and makes sealing of connection easier. It also provides support for cable insulation to improve vibration performance. A connection hole 18 is formed in the pad portion 14. A pin (not shown) is provided inside this connection hole 18, to provide grounding for the structure and the objects that the structure is connected to. It is to be appreciated that the pin placed inside the connecting hole 18 may be a rod, a metallic object, or other suitable object that forms a connection to transfer a grounding effect.

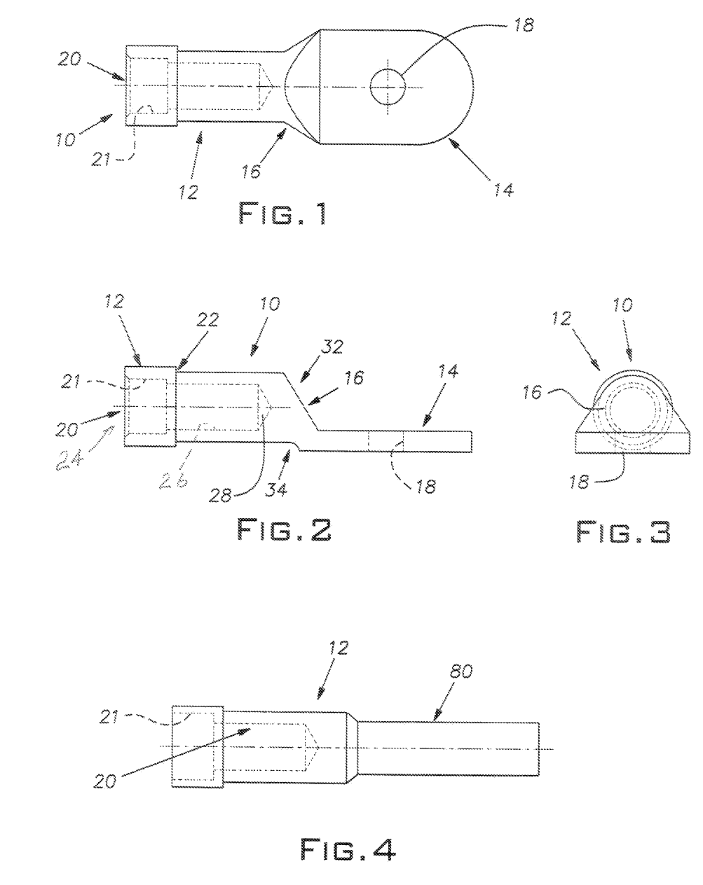

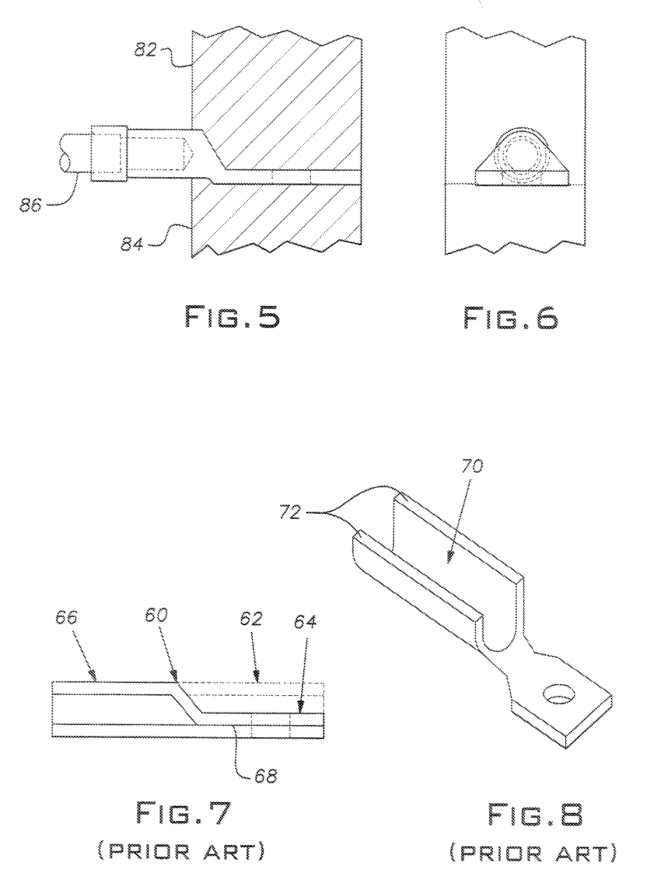

Referring to FIG. 2, a shoulder or flange 22 is provided on the ferrule portion 12. The shoulder 22 is used as a guide for heat shrink sealing to be applied to the ferrule portion 12. Heat shrink sealing will help to provide additional insulation and provides a secure placement of installation over the ferrule portion 12. The ferrule portion 12 helps to improve the performance of the lug terminal for the pull out value, vibration, weight testing, humidity, and hydrostatic properties. Furthermore, in one embodiment, the shoulder 22 can be used to form uniform ferrule portion thickness throughout the blind bore. In this embodiment, the shoulder 22 corresponds to the difference in diameter between the counterbore and a narrow bore area 26.

The bore 20 is provided inside the middle of the ferrule portion 12. A solid rod is formed into the terminal 10. By drilling out the bore 20 from the ferrule portion 12, a consistent grounding cable insert depth is provided on each terminal 10 that is manufactured. Providing a more consistent inside wire diameter for the terminal 10, results in increased performance, and a reduced chance of the wire slipping out of the assembly 10 or of reducing the connectivity between the grounding wire and the lug terminal 10. In FIG. 2, the counterbore 21 has a wide entrance area 24, which leads into a narrow bore 20. It is to be appreciated that the wide entrance area may become narrower when approaching the pad portion 14. An end area 28 is provided that culminates in a point. Providing the end area 28 with angled walls helps to ensure proper connection between the grounding wire and the terminal 10. Proper connection helps to further reduce the existence or buildup of any static electricity that may occur.

FIG. 2 also illustrates the transition area 16 to withstand larger forces applied to the pad portion 14 and the connecting hole 18. The transition area 16 provides a connection between the ferrule portion 12 and the pad portion 14. The pad portion 14 has a thickness that is much less than the diameter of the ferrule portion 12. An angled face 32 is provided in the transition area 16 that slopes from the top of the ferrule portion 12 to the top of the pad portion 14. The transition area 16 also comprises an angled edge 34 starting from the bottom of the ferrule portion, and leading to the bottom of the pad portion 14. Providing either one of or both an angled face 32 and an angled edge 34 helps to provide additional stability for the terminal 10 as it is subjected to increased forces.

The terminal 10 can be manufactured in multiple ways so long as the connector is unitary and seamless. The terminal 10 is manufactured from a solid rod 80 as shown in FIG. 4. The solid rod is first cut to the desired length and then turned to the form illustrated in FIG. 4. The turning operation results in the creation of a ferrule portion of a predetermined diameter as shown in FIG. 4. The turning operation creates a shoulder or a flange 22 on the ferrule portion 12 of the solid rod. The ferrule portion 12 is drilled to produce the bore 20 and the counterbore 21.

Referring now to FIGS. 5 and 6, the rod 80 is placed between the upper and lower coining dies 82 and 84, a retaining rod 86 is inserted into the bore 20 and counterbore 21. The dies 82 and 84 are closed to the position illustrated in FIGS. 5 and 6 and the terminal 10 is formed or coined to shape.

The connection hole 18 is punched through the pad portion 14. The terminal is then deburred and nickel plated.

Deburring is an important step to ensure that the grounding wire or the structure inserted into the connecting hole is not frayed or damaged in any way. In another embodiment, an additional drilling step can be taken to achieve a better connection. In this step, the inner diameter of the aperture located in the ferrule portion can be re-drilled to an exact, desired wire hole size.

It is to be appreciated that other manufacturing processes can be used to produce the present invention. For example, the present invention can be manufactured from a casting operation or a permanent mold. Furthermore, the present invention can be cold forged, formed from impact, produced by powder metallurgy, formed from a tube that is brazed or has a soldered seam, or formed from machinery operations and turned.

It should be evident that this disclosure is by way of example and that various changes may be made by adding, modifying, or eliminating details without departing from the fair scope of the teaching contained in this disclosure.

1. A grounding connector comprising a ferrule portion, a transition portion, and a pad portion, said ferrule portion having a conductor receiving bore terminating adjacent said transition portion, said transition portion sloping downward from the ferrule portion toward said pad portion to form an obtuse angle with said pad portion, said grounding connector being unitary and seamless.

2. A grounding connector according to claim 1 wherein the conductor receiving bore is provided with a counter bore.

3. A grounding connector according to claim 1 wherein an aperture is provided in said pad.

4. A grounding connector according to claim 1 wherein the connector is plated copper.

5. A method of making a grounding connector comprising the steps of cutting a metal rod to a predetermined length, turning the rod to a predetermined diameter, providing a bore in one end of the rod, and coining said rod to form a ferrule portion, a transition portion and a pad portion, said transition portion sloping downwardly from the ferrule portion toward said pad portion to form an obtuse angle with said pad portion.

6. A method of making a grounding connector according to claim 5 including the step of providing a counterbore in said ferrule.

7. A method of making a grounding connector according to claim 6 including the step of providing an aperture in said pad portion.
